(19) United States
(12) Patent Application Publication
(10) Pub. No.: US 2007/0030337 A1
(43) Pub. Date: Feb. 8, 2007

(54) Wireless Audio System With Remote Control

(76) Inventor: Montez D. Smith, Schaumburg, IL (US)

Correspondence Address: THE INVENTORS NETWORK, INC., 332 ACADEMY STREET, CARNEGIE, PA, 15106, US

(21) Appl. No.: 11/161,444

(22) Filed: Aug. 3, 2005

(51) Int. Cl. H04N 7/14

(52) U.S. Cl. 348/14.01

(57) ABSTRACT

A wireless portable audio/video system for delivering audio to the individual without the use of wires is used in conjunction with both portable and non-portable audio and/or video systems and devices includes a pair of ear buds or earplugs having speaker portions insertable into the ear holes for the delivery of audio thereto and a remote control unit for operating the system so that audio signals can be transmitted from the audio and/or video device to the receivers of the ear buds whereupon the electrical audio signals are transformed into acoustical power and conveyed via the speaker portions to the ears for the private listening of the individual.

### FIELD OF THE INVENTION

The present invention pertains to audio transmission and receiving systems, and more particularly pertains to audio transmission from both remote control operated portable and non-portable audio/visual systems and devices to ear buds or earplugs worn by the individual.

### DESCRIPTION

Within the last 15 years portable electronic devices have proliferated in popularity and use. They have become an indispensable part of daily life, crucial for commerce and business, and a fixture in the social environment for conversation and communication. The portable electronic revolution has now been established through such devices as pdas and Blackberries to walkmans and cell phones with digital photographic capabilities to portable CD players and MP3 players. The electronic revolution has occurred in concert with the revolution in microelectronics that has shrunk integrated circuits from thumbnail size to pinhead size and, for some applications, to sand granule size.

The above devices provide for the access, transmission, downloading, saving, exchange and playing of audio, video and text data and files, and because of the micro electronic revolution, are generally portable and can be carried in one's pocket, backpack or clipped or attached to one's belt or other article of clothing. Thus, an individual can conduct business, stay in communication, and partake of both audio and video entertainment. However, many of the above devices require the use of wires extending from the device and connecting to ear buds or headphones for the conveyance of audio—which in the majority of cases would be music. This severely limits the flexibility of use of the device as well as requiring the use of wires that invariably get tangled up and become an annoyance and inconvenience, especially when the individual is using the device, e.g. the portable CD player or walkman, while engaging in a non-sedentary activity such as walking, jogging, doing light household work, traveling or sightseeing and must keep the ear buds or headphones in place but avoid entanglement in the wires that could lead to the displacement of the ear buds or headphones. Thus, it would be desirable to utilize a wireless system that would obviate the need for the inconvenience of wires and could also incorporate non-portable audio/video systems such as console televisions and CD/DVD players whereupon the individual could receive audio signals while remaining free to move about without being tethered to the device by wires.

For example, the Minasian patent (U.S. Pat. No. 3,821,647) discloses a radio receiving means that includes an earpiece assembly insertable into the ear with the assembly including a transducer for converting electrical energy into audio energy.

The Norris patent (U.S. Pat. No. 4,539,708) discloses an ear radio that includes a self-contained radio device that includes a speaker and radio circuitry that includes signal receiving, amplifying and filtering circuitry.

The Yokoyama et al. patent (U.S. Pat. No. 4,736,435) discloses an earpiece transducer that includes an electro-acoustic transducer for minimizing discordant aural sensations by using an electro-acoustic transducer element.

The Reddemann et al. patent (U.S. Pat. No. 5,073,947) discloses a hearing device for a helmet that includes a receiver and transmitter device mounted to the helmet for transmitting audio signals to an earplug that includes a receiver and a transformer.

The Norris patent (U.S. Pat. No. 5,313,663) discloses an ear mounted RF receiver that includes a casement for housing an antenna, a circuit board, a battery compartment and a tuning circuit selector switch.

The Yoshimi patent (U.S. Pat. No. 5,396,563) discloses an earphone that includes an earplug of sound insulating material and a vibration generator for transmitting auditory signals to the earplug.

The Callahan patent (U.S. Pat. No. 5,917,918) discloses an ear-in-canal audio receiver that includes a transducer assembly that can accommodate and be used in conjunction with an electronic stethoscope.

Nonetheless, despite the ingenuity of the above devices, there remains a need for a wireless system capable of transmitting audio signals from both portable and non-portable audio and video systems to an ear bud or earplug worn by an individual.

### SUMMARY OF THE INVENTION

The present invention comprehends a wireless portable audio system that includes ear buds or earplugs and a remote control unit used in conjunction with various audio/video devices and systems for providing audio to an individual without the need for wires running from the audio/video devices and systems to the ear buds that are inserted in the ear holes of the individual.

Thus, the present invention includes at least one pair of ear buds or earplugs for placement within the ear holes of the individual's ears. Each ear bud includes such electrical components as an antenna, a receiver, an amplifier, rectifiers, and a speaker portion interconnected to and controlled by a microprocessor. The ear buds are used in conjunction with a manually operable remote control unit and various types of audio/video devices and systems to control and deliver audio signals to the ear buds without the need for entangling wires to convey such audio signals. The audio and/or video devices and systems can include portable and non-portable devices and systems such as CD players, fm-am walkman cassette player (remote), CD-DVD players, DVD players, console television sets such as flat screen LCD displays and even full home entertainment systems that include some of the aforedescribed devices. The present invention is accord with the current trend of adapting or making electronic devices suitable for wireless communication such as wireless cell phone, pda, and Internet connection and communication.

It is an objective of the present invention to provide a wireless portable audio system for use in conjunction with both portable and non-portable audio and video systems operable by remote control for transmitting audio signals from such systems to an ear bud or earplug worn by the individual.

It is another objective of the present invention to provide a wireless portable audio system with remote control wherein the individual can privately listen to audio transmitted from both portable and non-portable systems without disturbing anyone else in their vicinity.

It is still yet another objective of the present invention to provide a wireless portable audio system with remote control that eliminates the inconvenience of wires to transmit the audio signals to the ear buds or earplugs that are worn by the individual.

Still yet another objective of the present invention is to provide a wireless portable audio system with remote control that eliminates the need to use headphones to deliver audio signals to the individual.

Still another objective of the present invention is to provide a wireless portable audio system with remote control that can be used with portable and non-portable audio and video systems such as am-fm stereo cassette walkmans, CD players, DVD players, and various television systems combining CD and DVD functions.

Still yet a further objective of the present invention is to provide a wireless entertainment capability operable through a standard remote control unit.

Another objective of the present invention is to provide a wireless portable audio system wherein ear buds are placed within the ear holes of the individual and are used in conjunction with a remote control unit for the transmission and reception of audio signals from portable and non-portable audio and/or video devices and systems.

Yet a further objective of the present invention is to provide a wireless audio system that includes either ear buds or headphones for use with both portable and remote audio devices and systems.

A further objective of the present invention is to provide a wireless portable audio system that is compact, reliable and easy to install and use as desired.

These and other objects, features and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the wireless portable audio system with remote control of the present invention illustrating a portable audio device attachable to the individual's clothing, a handheld remote control unit, and an ear bud for receiving the audio signals from the portable audio playing device;

FIG. 2 is a perspective view of the wireless portable audio system with remote control of the present invention illustrating a pair of ear buds, a remote control unit, and a portable audio playing device;

FIG. 3 is a perspective view of the wireless portable audio system with remote control of the present invention illustrating one ear bud for placement in the individual's ear for receiving audio signals from the portable audio playing device;

FIG. 4 is a front elevational view of the wireless portable audio system with remote control of the present invention illustrating the signal transmission route for the handheld remote control unit, the portable audio playing device, and the ear buds;

FIG. 5 is a perspective view of the wireless portable audio system with remote control of the present invention illustrating the use of the ear buds and the remote control unit with a table-mounted audio playing device;

FIG. 6 is a perspective view of the wireless portable audio system with remote control of the present invention illustrating the use of the ear buds and the remote control with an audio/video device such as a DVD/CD player; and

FIG. 7 is schematic view of the wireless portable audio system with remote control of the present invention illustrating a representative electrical schematic interconnecting the ear buds, the remote control unit, and the portable audio playing device.

### DETAILED DESCRIPTION OF THE PREFERRED EMBODIMENT

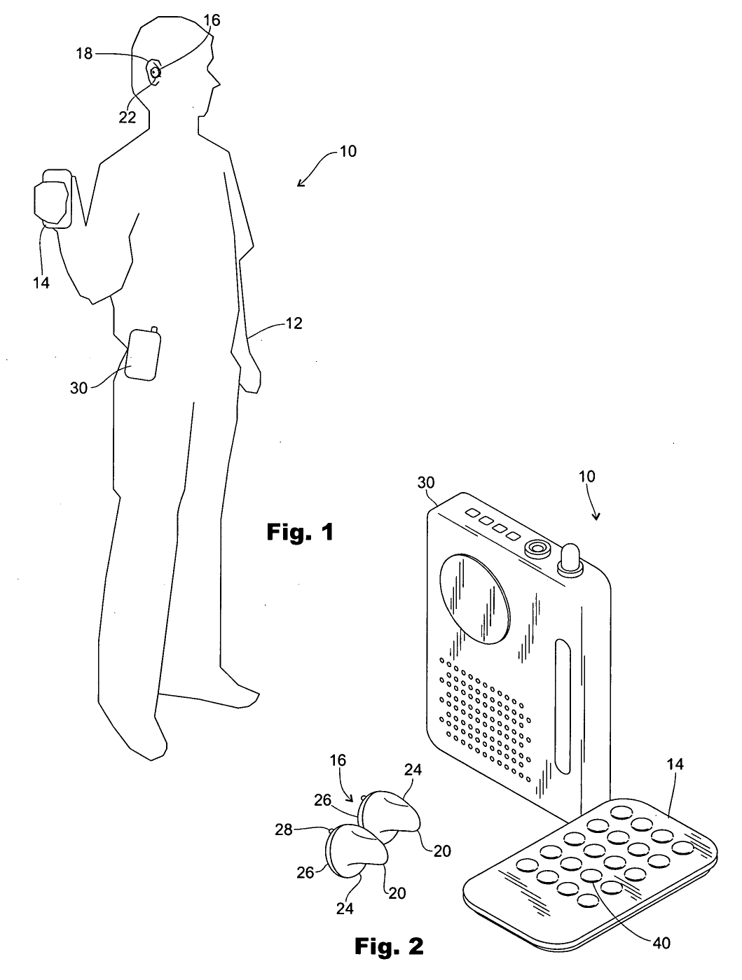

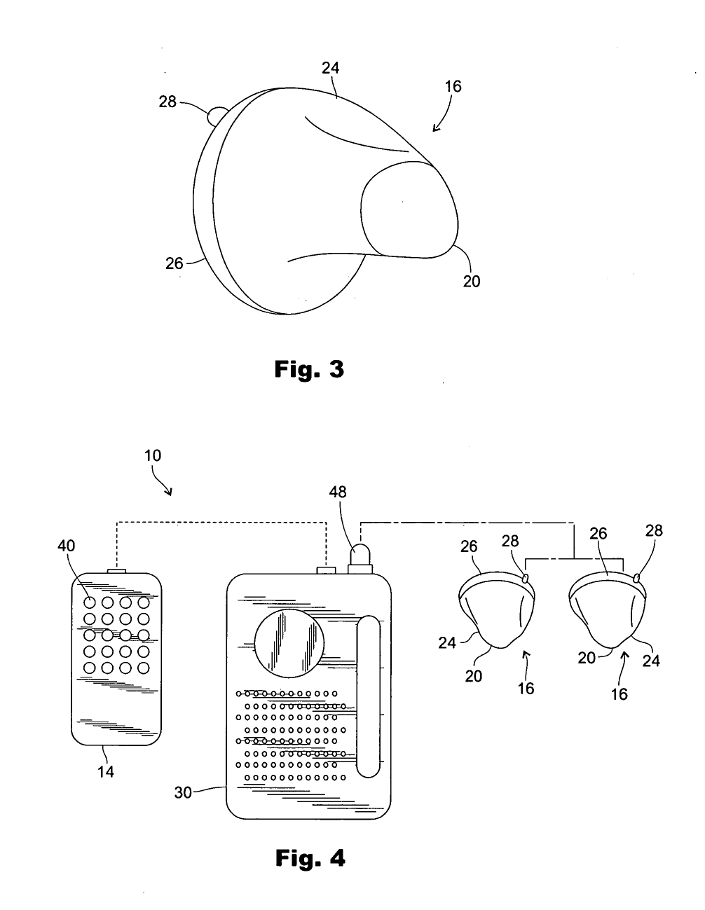

Illustrated in FIGS. 1-7 is a preferred embodiment of the present invention in the form wireless portable audio system 10 for delivering audio to an individual 12 from various devices and systems—both portable and non-portable—without the annoyance and entangling inconvenience of wires that normally would run from the device or system to earpieces mounted to the ears of the individual. The wireless audio system 10 is used in conjunction with a remote control unit 14 programmed to operate the various kinds of portable and non-portable audio and/or video devices. Among the portable audio devices and systems that can be used with the present invention are am-fm stereo cassette Walkmans, CD players (commonly known as “Discmans”), MP3 players; among the non-portable audio/video devices and systems that can be used with the present invention are CD players, CD-DVD players, and various types of television sets such console TV's, flat screen (LCD) screens. For illustrative purposes FIGS. 1-7 show representative audio/video devices being used in conjunction with and as part of the wireless portable audio system 10 that incorporates earpieces and the remote control unit 14.

Thus, as shown in FIGS. 1-7, the present invention includes at least one pair of earpieces 16 with each earpiece 16 mounted to each ear 18 of the individual 12. The earpieces 16 can be in the form of ear buds or earplugs. In addition, headphones can also be used with the wireless audio system 10. Each earpiece 16 includes an elongated speaker portion 20 that actually inserts into the ear hole 22 of the ear 18 so that acoustical power can be delivered thereto. The speaker portion 20 is part of a component housing 24 that encases and protects electrical circuitry therein, and that will be more fully described hereinafter. The earpiece 16 includes a generally circular facing surface 16, and extending from the facing surface 16 is an antenna 28 for picking up electrical signals remotely transmitted from the respective audio/video device or system to the earpiece 16. The earpieces 16 do not need to be tethered to the audio/video device or system by wires through the use of the built-in remote antenna-receiver capability of the earpiece 16.

As shown in FIGS. 2 and 4-7, the wireless audio system 10 will also include the remote control unit 14 for operating the particular audio and/or video device or system that may be either portable or non-portable. The remote control unit 14 will include the standard functions such as on/off, volume control, channel + and −, menu, set-up, mute, sleep, reset, quick view, etc. The remote control unit 14 will be programmed for that respective audio/video device or system, and will also be compatible with the earpiece 16.

FIGS. 1-7 illustrate a number of representative possible configurations of use for the wireless audio system 10 of the present invention. In FIG. 1 the individual 12 has a portable audio device 30, such as an am-fm stereo cassette Walkman, attached to his belt. The individual 12 is holding the remote control unit 14 and one earpiece 16 is shown placed within the ear 18 of the individual 12. The remote control unit 14 controls the operation of the portable audio device 30 so that electrical signals can be sent from the portable audio device 30 to the earpiece 16 where they are transformed into acoustical energy for the private listening enjoyment of the individual 12.

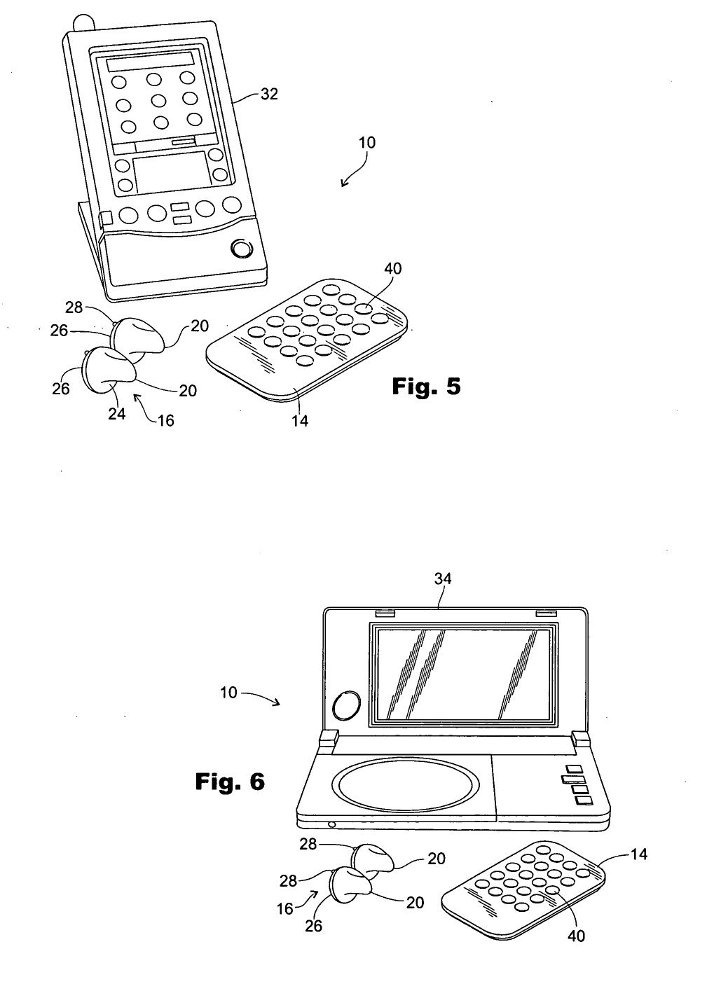

FIG. 4 illustrates a representative signal transmission route for operating the wireless audio system 10. As shown in FIG. 4 the transmission route goes from the remote control unit 14 powering on the portable audio device 30, and with the desired track, station, or channel selected, the audio device 30 then transmitting electrical signals to the earpieces 16, whereupon the circuitry of the earpieces 16 conform the signals into acoustical energy that is privately heard by the individual 12 as, for example, the desired music.

FIG. 5 illustrates the wireless audio system 10 used in conjunction with a small audio device 32 while FIG. 6 shows the earpieces 16 and remote control unit 14 used in conjunction with an audio device 34 such as a DVD player.

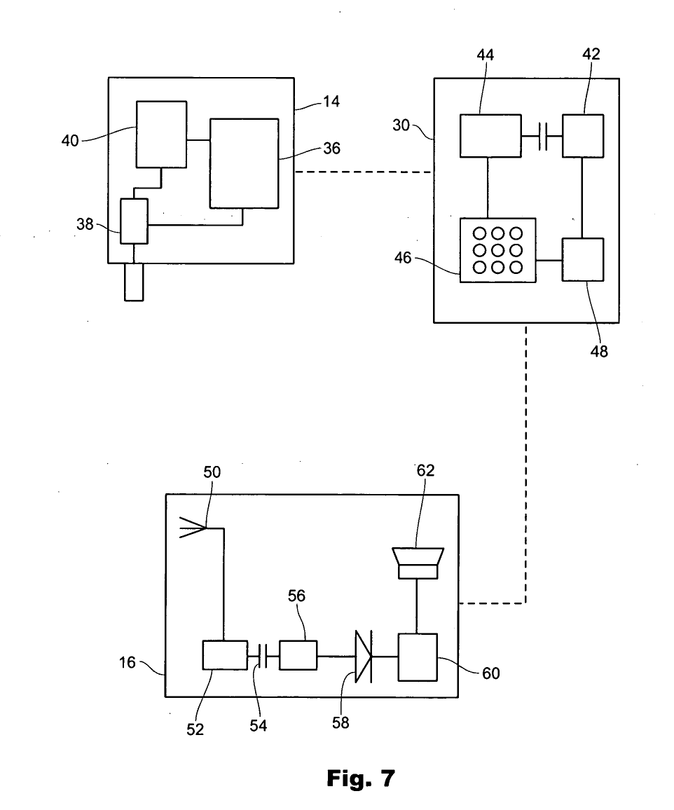

FIG. 7 illustrates one possible representative electrical schematic for the wireless audio system 10 that incorporates the remote control unit 14, the portable audio device 30, and the earpiece 16. The remote control unit 14 will include a microprocessor 36 and a transmitter 38 to transmit the electromagnetic signal (by the appropriate frequency) to the portable audio device 30. A button pad 40 is interconnected to the microprocessor 36 for selecting and engaging the numerous keypad functions of the remote control unit 14. The portable audio device 30 includes a number of electrical components the primary ones being a microprocessor 42, a power source 44 (such as nickel/cadmium batteries), button pads 46 for controlling and engaging the standard functions on the portable audio device 30, and a transmitter 48. The transmitter 48 conveys electrical signals to the earpiece 16 (actually both earpieces but only one is shown by way of example in FIG. 7). The earpiece 16 includes a number of components for transforming the electrical signals into acoustical energy that are then privately heard by the individual 12. Thus, the earpiece 16 includes an antenna 50 for collecting the electrical signals and a receiver 52 that decodes the electrical signals. A capacitator 54, a transducer 56, and a diode 58 are components that transform the alternating current into direct current as all components are controlled by the microprocessor 60, and a speaker 62 delivers the transformed electrical signals as acoustical energy to the ears 18. It should be noted that the signal transmission route or path among the devices 14, 16 and 30 is shown by way of broken lines to indicate that wiring is not used or needed for the operation of the system 10 and that the entire system 10 is wireless.

While particular embodiments of the present invention have been shown and described, it will be obvious to those skilled in the art that numerous modifications, alterations, and variations may be made without departing from the spirit of the invention and the scope of the appended claims such that all modifications shall fall within the scope of the appended claims and the spirit of the invention.

What is claimed is:

1. A wireless portable audio/video system for transmitting electrical signals to an ear of an individual so that the electrical signals are conformed to acoustical energy for reception by the ear of an individual, comprising:
an earpiece for placement within the ear of the individual, the earpiece including an antenna for picking up the electrical signals, a receiver for transforming the electrical signals into acoustical energy, a speaker for directing the acoustical energy to the ear of the individual, and a microprocessor for controlling the functions of the earpiece;
a portable audio device remote from the earpiece for transmitting electrical signals to the earpiece over a wireless transmission path;
a remote control unit programmed to operate and control the portable audio device; and
whereupon wireless transmission paths are established among the earpiece, the portable audio device and the remote control unit so that audio can be delivered remotely to the ear of the individual.

2. The wireless portable audio system of claim 1 wherein the portable audio device is an am-fm stereo cassette Walkman.

3. The wireless portable audio system of claim 2 wherein the portable audio device is a CD player.

4. A wireless portable audio/video system for transmitting electrical signals to the ears of an individual so that the electrical signals can be conformed to acoustical energy for the private listening by the individual, comprising:
a pair of earpieces with each earpiece placed within one ear, each earpiece including an antenna for picking up the electrical signals, a receiver for conforming the electrical signals into acoustical energy, a speaker for directing the acoustical energy into the ear, and a microprocessor for controlling the functions of the earpiece;
a non-portable audio/video device for transmitting electrical signals to the earpieces over wireless transmission paths;
a remote control unit programmed to operate and control the non-portable audio/video device; and
whereupon wireless transmission paths are established among the earpieces, the remote control unit, and the non-portable audio/video device for the non-wireless delivery of audio to the ears of the individual.

5. The wireless portable audio/video system of claim 4 wherein the non-portable audio/video device is a CD-DVD player.

6. The wireless portable audio/video system of claim 5 wherein the non-portable audio/video device is a television set.
